(19) United States
(12) Patent Application Publication
(10) Pub. No.: US 2026/0085645 A1
(43) Pub. Date: Mar. 26, 2026

(54) SEALED TANK SYSTEM

(71) Applicant: AISAN KOGYO KABUSHIKI KAISHA, Obu-shi (JP)

(72) Inventors: Yoshikazu MIYABE, Obu-shi (JP); Yuya TANAKA, Hekinan-shi (JP)

(73) Assignee: AISAN KOGYO KABUSHIKI KAISHA, Obu-shi (JP)

(21) Appl. No.: 19/313,989

(22) Filed: Aug. 29, 2025

(30) Foreign Application Priority Data
Sep. 26, 2024 (JP) 2024-167109

(51) Int. Cl. F02D 41/00; B01D 53/04; B60K 15/05; F02M 25/08

(52) U.S. Cl. CPC F02D 41/004; B01D 53/0415; B01D 53/0446; B01D 53/0454; B60K 15/05; F02M 25/0854; F02M 25/0872; B01D 2257/708; B01D 2259/4566; B60K 2015/0561

(57) ABSTRACT

A sealed tank system for a vehicle includes a canister that adsorbs and desorbs fuel vapor from the fuel tank. A vapor passage connects the fuel tank to the canister, and a purge passage links the canister to the engine's intake. A control unit implemented by at least one programmed processor manages a purge valve in the purge passage and a closing valve in the vapor passage. The vehicle also has a location information acquisition unit that acquires location information of the vehicle. When the control unit determines, based on the location information, that the closing valve is not needed, it remains open.

### CROSS-REFERENCE TO RELATED APPLICATIONS

This application claims priority to Japanese patent application serial number 2024-167109, filed Sep. 26, 2024, which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to sealed tank systems.

Plug-in hybrid vehicles (PHEVs) or hybrid vehicles (HVs) operate internal combustion engines less frequently than conventional gasoline cars. This reduces opportunities to purge hydrocarbons (HC) adsorbed in canisters. To meet evaporative emission regulations that limit the amount of fuel vapor released from the vehicle, these vehicles often require a sealed tank system with a sealed fuel tank structure. For example, existing conventional sealed tank system uses a closing valve in the vapor passage between the fuel tank and the canister. This valve, when closed, prevents fuel vapor from flowing into the canister through the vapor passage. However, such sealed tank systems are typically complex and expensive.

The evaporative emission regulations vary by country. Thus, in order to meet each regulation, the sealed tank system is required in some countries, while the sealed tank system is not necessary in other countries. In this disclosure, countries that require the sealed tank systems are referred to as “sealed countries”, while countries that do not require the sealed tank systems are referred to as “non-sealed countries”.

Vehicles equipped with sealed tank systems face inefficiency when crossing borders to a non-sealed country as they continue to perform evaporative emission control operations even in regions where these stringent measures aren't required. This unnecessary operation, stemming from a system designed for “sealed country” operating in a “non-sealed country,” creates a clear need for more adaptive and improved sealed tank systems.

### SUMMARY OF THE INVENTION

In one aspect of the present disclosure, a sealed tank system includes a canister configured to adsorb and desorb fuel vapor evaporated in a fuel tank of a vehicle, a vapor passage connecting the fuel tank to the canister, a purge passage connecting the canister to an intake passage of an engine, a control unit implemented by at least one programmed processor, a purge valve installed in the purge passage and controlled by the control unit, and a closing valve installed in the vapor passage and controlled by the control unit. The vehicle has a location information acquisition unit configured to acquire location information of the vehicle. The control unit is configured to maintain the closing valve in an open state when the control unit determines that the closing valve is not necessary based on the location information obtained by the location information acquisition unit.

### BRIEF DESCRIPTION OF THE DRAWINGS

FIG. 1 is a schematic view of an embodiment of a sealed tank system having a closing valve.

FIG. 2 is a cross-sectional view of the closing valve of FIG. 1 in a fully closed state.

FIG. 3 is a cross-sectional view of the closing valve of FIG. 1 in an open state.

FIG. 4 is a cross-sectional view of the closing valve of FIG. 1 in an initialized state.

FIG. 5 is a time chart for control by an electronic control unit when crossing a border from a sealed country to a non-sealed country.

FIG. 6 is a time chart for control by the electronic control unit when crossing a border from a non-sealed country to a sealed country.

### DETAILED DESCRIPTION

One embodiment of the present disclosure is described below in reference to the drawings.

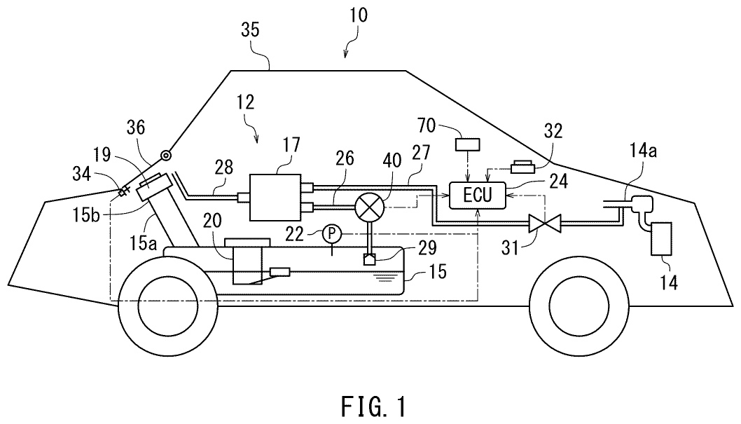

FIG. 1 is a schematic diagram of a sealed tank system 12. As shown in FIG. 1, the sealed tank system 12 is mounted on a vehicle 10 such as a PHEV or HV. The sealed tank system 12 includes an engine (internal combustion engine) 14, a fuel tank 15, and a canister 17. The fuel tank 15 has an inlet pipe 15a for introducing liquid fuel from a fuel inlet 15b of the inlet pipe 15a into the fuel tank 15. A fuel cap 19 is removably attached to the fuel inlet 15b.

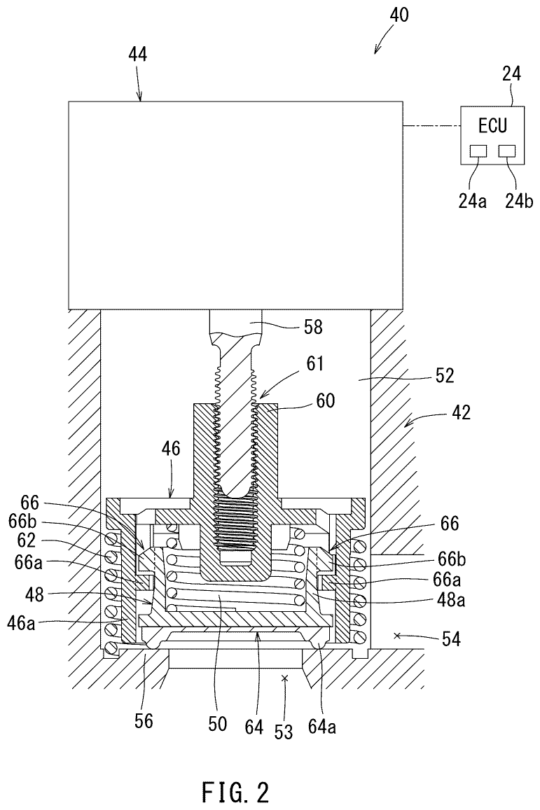

The fuel tank 15 houses a fuel supply system 20 therein. The fuel supply system 20 is configured to supply the fuel from the fuel tank 15 to the engine 14, specifically injectors of the engine 14. The fuel tank 15 is provided with an in-tank pressure sensor 22. The in-tank pressure sensor 22 is configured to measure the tank pressure as a pressure relative to the atmospheric pressure and to output a signal to an electronic control unit (ECU) 24 based on the measured value. The ECU 24 may be implemented by at least one programmed processor whose operation is determined by a predetermined program, gate arrays, and/or the like. The ECU 24 includes a processor 24a and a memory unit 24b (as seen in FIG. 2). The memory unit 24b may be formed of any suitable component, including a read-only memory, a random-access memory, or the like. The ECU 24 is configured to control various electric components of the vehicle 10 with the processor 24a by operating programs stored in the memory unit 24b.

A vapor passage 26 links the fuel tank 15 (specifically, its gas layer) to the canister 17. A purge passage 27 connects the canister 17 to an intake passage 14a of the engine 14. The canister 17 is also open to the atmosphere via an atmospheric passage 28. The canister 17 is filled with an activated carbon as an adsorbent which adsorbs and desorbs fuel vapor, primarily hydrocarbons (HC). When fuel vapor evaporates in the fuel tank 15 and flows into the canister 17 through the vapor passage 26, the activated carbon traps these hydrocarbons in the fuel vapor, preventing their release into the atmosphere through the atmospheric passage 28.

An On-Board Refueling Vapor Recovery (ORVR) valve 29 is provided at an upstream end (tank side end) of the vapor passage 26. The ORVR valve 29 is a float valve configured to open and close based on the buoyancy of a float and serves as a full tank regulation valve. When the fuel level in the fuel tank 15 is below the full tank level, the ORVR valve 29 is open. And, when the fuel level rises to the full tank level due to fueling, the ORVR valve 29 closes to shut off the vapor passage 26. Then, the fuel fills up to the inlet pipe 15a, and the auto-stop mechanism of the fuel gun operates to stop fueling.

The purge passage 27 has a purge valve 31 that is a solenoid valve capable of adjusting the opening amount by duty control. The purge valve 31 remains closed when not energized and opens when energized. The ECU 24 controls the opening amount of the purge valve 31 in response to the purge flow rate, in other words, performs the purge operation. The purge valve 31 can finely adjust the amount of the hydrocarbons purged from the canister 17 to the intake passage 14a. Accordingly, the purged hydrocarbons can be burned without disturbing the air-fuel ratio of the engine 14.

The ECU 24 is connected to a fuel door release switch 32 and a fuel door switch 34. The fuel door release switch 32 is located in the interior of the vehicle 10. Before starting fueling, the user operates the fuel door release switch 32 to output an operation signal to the ECU 24.

The fuel door switch 34 usually locks a fuel door 36 of a vehicle body 35 of the vehicle 10 in the closed position. The fuel door switch 34 unlocks the fuel door 36 when receiving an unlock signal from the ECU 24. Thus, the use can open the fuel door 36 by operating the fuel door release switch 32. While the fuel door 36 opens, the user can access the fuel inlet 15b for fueling.

The vapor passage 26 has a closing valve 40. The ECU 24 controls the closing valve 40 to open and close in response to the tank pressure for pressure relief of the fuel tank 15. Further, the ECU 24 properly controls the power supply and operations of all electronic components in the vehicle 10.

The basic operation of the sealed tank system 12 is described below. (1) In a first case, while the vehicle 10 is parked, the closing valve 40 is maintained in a fully closed state. Consequently, no fuel vapor is permitted to flow from the fuel tank 15 into the canister 17. Similarly, the purge valve 31 is also kept fully closed. When no purge operation is being performed during parking, the fuel vapor evaporated within the fuel tank 15 is completely prevented from entering the canister 17. This significantly reduces the amount of hydrocarbons adsorbed in the canister 17. Through this hydrocarbon control, vehicles like PHEVs or HVs, which typically have fewer opportunities for purging, can effectively meet evaporative emission regulations.
(2) In a second case, while the vehicle 10 is running, the ECU 24 performs a purge operation under predetermined purge conditions. When the purge valve 31 opens, the intake negative pressure of the engine 14 acts on the canister 17 via the purge passage 27. As a result, the hydrocarbons are desorbed from the activated carbon filled in the canister 17 and flown into the intake passage 14a, simultaneously drawing in air via the atmospheric passage 28. Concurrently, the ECU 24 opens the closing valve 40 to allow the fuel vapor from the fuel tank 15 into the canister 17. This action reduces fuel vapor in the fuel tank 15 and preserves the activated carbon's ability to adsorb hydrocarbons, preventing atmospheric emissions.

The internal pressure of the fuel tank 15 is maintained at the atmospheric pressure by keeping the closing valve 40 open. If the internal pressure of the fuel tank 15 increase while the vehicle 10 is running, this pressure can be relieved by opening the closing valve 40, simultaneously with a purge operation. Conversely, when the purge valve 31 is closed, the purge flow ceases.
(3) In a third case, when the user operates the fuel door release switch 32 while the vehicle 10 is parked, the ECU 24 fully opens the closing valve 40. If the internal pressure of the fuel tank 15 exceeds atmospheric pressure at this point, a depressurization process of the fuel tank 15 begins. During this depressurization, the user cannot open the fuel door 36 because the fuel door switch 34 locks the fuel door 36. This crucial safety measure prevents fuel from spurting out due to high tank pressure when the fuel cap 19 is eventually opened.

When the closing valve 40 opens, fuel vapor flows from the fuel tank 15 via the vapor passage 26 to the canister 17, where hydrocarbons contained in the fuel vapor are adsorbed by activated carbon in the canister 17. The opening amount of the closing valve 40 is adjusted to ensure a slow, controlled release of the fuel vapor to the canister 17, gradually decreasing the internal pressure of the fuel tank 15. Once the tank pressure of the fuel tank 15 matches atmospheric pressure, the ECU 24 sends an unlock signal to the fuel door switch 34, unlocking the fuel door 36. The user can then open the fuel door 36, remove the fuel cap 19, and insert the fuel gun into the fuel inlet 15b for fueling.

The ECU 24 keeps the closing valve 40 fully open until the fuel door 36 closes. This allows fuel vapor to flow from the fuel tank 15 to the canister 17 via the vapor passage 26 during fueling. After fueling is complete, the user removes the fuel gun from fuel inlet 15b, reattaches the fuel cap 19 to the fuel inlet 15b, and closes the fuel door 36. The fuel door switch 34 then locks the fuel door 36. Upon receiving the lock signal from the fuel door switch 34 and detecting the end of fueling, the ECU 24 fully closes the closing valve 40, sealing the fuel tank 15.

The specific features of this embodiment are described below. As shown in FIG. 1, the vehicle 10 includes a location information acquisition unit 70. The location information acquisition unit 70 obtains the location information through communication with external systems, such as navigation systems, and forwards the location information to the ECU 24. The ECU 24 then uses this location information to determine if sealing the fuel tank 15 by the closing valve 40 is unnecessary. If the ECU 24 determines that the closing valve 40 is not needed, it keeps the closing valve 40 fully open. This effectively switches the sealed tank system 12 to a non-sealed setting, for example, when the vehicle 10 has completely crossed the border from a country requiring sealed tank to a country that does not.

When the ECU 24 then determines that the closing valve 40 is necessary to seal the fuel tank 15 based on the location information obtained by the location information acquisition unit 70, the ECU 24 operates the closing valve 40 normally. In other words, when the vehicle 10 has completely crossed the border from a non-sealed country to a sealed country, the sealed tank system 12 is switched to the normal operation.

The closing valve 40 is an electric valve having a stepping motor. The closing valve 40 is configured to control the stroke amount of its closure member to adjust the opening amount thereof. FIG. 2 is an axially cross-sectional view of the closing valve 40 in the fully closed state. The front, rear, left, right, up, and down directions of the closing valve 40 are defined based on FIG. 2. As shown in FIG. 2, the closing valve 40 has a valve housing 42, a stepping motor 44, a valve guide 46, a closure member 48, and a valve spring 50.

The valve housing 42 defines a valve chamber 52 therein. The valve chamber 52 has a cylindrical shape with a partially closed bottom. The bottom wall of the valve housing 42 forms an inflow opening 53 that is fluidly connected to the valve chamber 52. A side wall of the valve housing 42 forms an outflow opening 54 that is connected to the valve chamber 52. The inflow opening 53 is connected to the vapor passage 26 on the fuel tank 15 side, and the outflow opening 54 is connected to the vapor passage 26 on the canister 17 side (as seen in FIG. 1). The bottom surface of the valve housing 42 forms an annular valve seat 56 at the periphery of the inflow opening 53.

The stepping motor 44 is installed to close the top opening of the valve housing 42. The stepping motor 44 has an output shaft 58 that can rotate forward and reverse. The output shaft 58 protrudes into the valve chamber 52.

The valve guide 46 has a hollow cylindrical shape with a top. The top wall of the valve guide 46 has a threaded tube portion 60 in the form of a bottomed cylindrical shape. The valve guide 46 is movable in the valve chamber 52 in the vertical direction, i.e., in the axial direction. The valve guide 46 is secured against rotation around the axis relative to the valve housing 42. The threaded tube portion 60 is connected to the output shaft 58 of the stepping motor 44 via a feed screw mechanism 61. Thus, the valve guide 46 is moved in a linear reciprocating motion in the axial direction, i.e., raised and lowered in response to the forward and reverse rotation of the output shaft 58.

An auxiliary spring 62 is interposed between the valve guide 46 and the bottom wall of the valve housing 42. The auxiliary spring 62 is composed of a coil spring. The auxiliary spring 62 is located on the outer circumference of the valve guide 46. The auxiliary spring 62 constantly biases the valve guide 46 upward to prevent backlash of the feed screw mechanism 61.

The closure member 48 is a hollow cylindrical shape with a closed bottom, housed within the valve guide 46 for vertical movement. The closure member 48 is secured against rotation relative to the valve guide 46. A disc-shaped seal member 64, made of a rubber-like elastic material, is attached to the lower surface of the closure member 48. An annular seal portion 64a, with a triangular axial cross-section, protrudes downward from the outer periphery of the lower surface of the seal member 64.

The valve spring 50 is composed of a coil spring and is interposed between valve guide 46 and the closure member 48. The valve spring 50 biases the valve guide 46 and the closure member 48 in opposite directions.

Between the valve guide 46 and the closure member 48, a plurality of coupling mechanisms 66 are provided (two connecting mechanisms 66 are shown in FIG. 2). Each of the coupling mechanisms 66 is composed of an engaging projection 66a formed on an inner surface of a side wall 46a of the valve guide 46 and an engaged projection 66b formed on an outer surface of a side wall 48a of the closure member 48. The engaging projection 66a and the engaged projection 66b of each coupling member 66 are configured to contact each other in the axial direction.

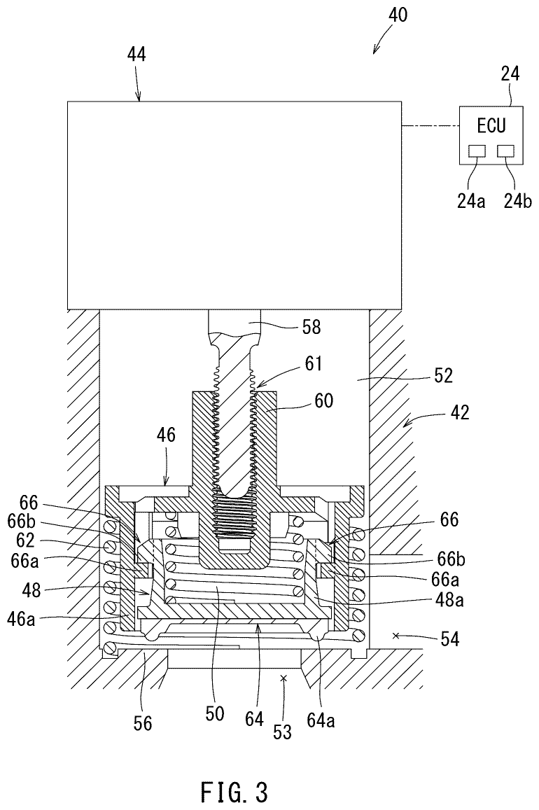

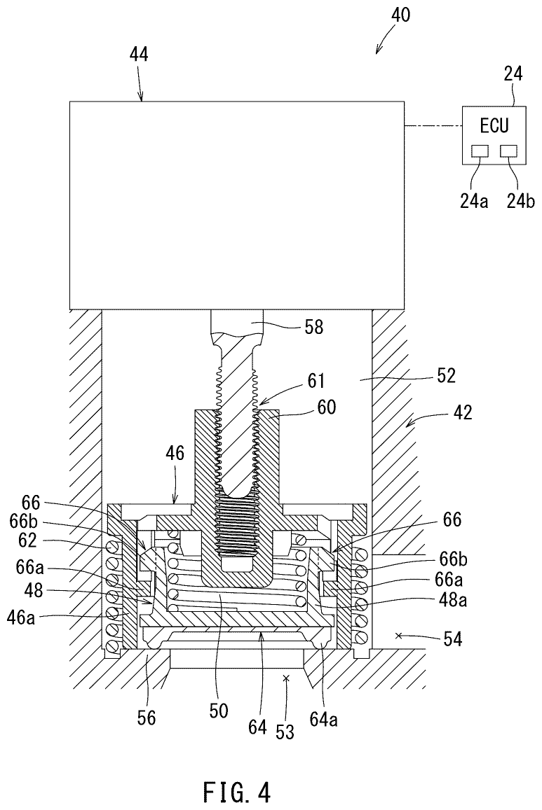

The operation of the closing valve 40 is described below. (1) In its fully closed state (as seen in FIG. 2), the closure member 48, specifically, the seal portion 64a of the seal member 64, is firmly seated on the valve seat 56 by the biasing force of the valve spring 50. In this configuration, the engaging projections 66a and the engaged projections 66b of the coupling mechanisms 66 are separated. The closing valve 40 remains fully closed, even when the stepping motor 44 is de-energized, due to factors such as the detent torque and the lead angle of the feed screw mechanism 61.
(2) When the stepping motor 44 operates to open the closing valve 40 from its fully closed state (as seen in FIG. 2), the valve guide 46 is raised via the feed screw mechanism 61. Simultaneously, the valve spring 50 extends due to its elastic restoring force. After the engaging projections 66a and the engaged projections 66b of the coupling mechanisms 66 contact each other, the valve guide 46 and closure member 48 move upward in unison. This means that the stepping motor 44 controls the axial stroke of the closure member 48 via the feed screw mechanism 61. As a result, the seal portion 64a of the seal member 64 of the closure member 48 detaches from the valve seat 56, opening the closing valve 40 (as shown in FIG. 3). In this open state, the closing valve 40 remains open, even if the stepping motor 44 is de-energized, due to factors such as the detent torque and the lead angle of the feed screw mechanism 61.
(3) When the stepping motor 44 operates to close the closing valve 40 from its open state (as seen in FIG. 3), the closure member 48 is lowered together with the valve guide 46 via the feed screw mechanism 61. Once the sealing portion 64a of the sealing member 64 seats on the valve seat 56, the downward movement of the closure member 48 stops. As the valve guide 46 continues to descend, the engaging projections 66a of the coupling mechanisms 66 separate from the engaged projections 66b. The ECU 24 then stops the closing operation of the stepping motor 44 before the side wall 46a of the valve guide 46 contacts the valve seat 56, returning the closing valve 40 to its fully closed state (as seen in FIG. 2).
(4) The initialization of the closing valve 40, specifically, setting the origin position of the stepping motor 44, is described. For initializing the closing valve 40, the stepping motor 44 operates to close the closing valve 40 from its open state until the side wall 46a of the valve guide 46 abuts the valve seat 56 of the valve housing 42 (as seen in FIG. 4). The point at which the stepping motor 44 loses synchronization while restricting the downward movement of the valve guide 46 is then designated as the origin position of the stepping motor 44. This origin position serves as a crucial reference for subsequent drive control of the stepping motor 44. The initialization of the closing valve 40 is essential under various conditions, including when the ignition of the vehicle 10 is turned on or off, and when the On-Board Diagnosis (OBD) for the sealed tank system 12 commences.

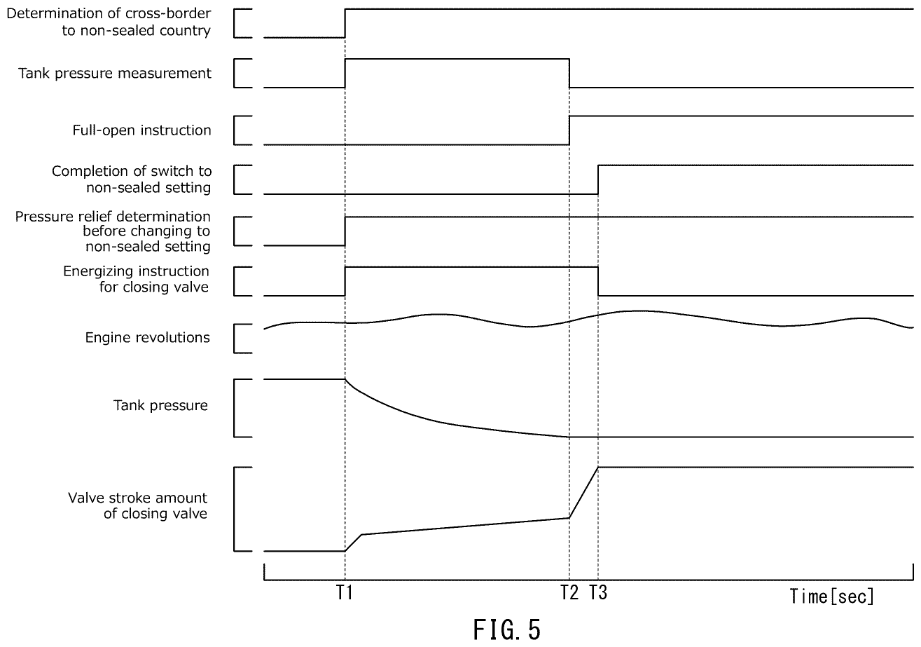

The control by the ECU 24 when the vehicle crosses a border from a “sealed country” to a “non-sealed country” is described. As illustrated in the time chart of FIG. 5, at time T1, if the ECU 24 determines that the vehicle 10 has entered a non-sealed country based on the location information while the engine 14 is running, the tank pressure, specifically the internal pressure of the fuel tank 15, is measured. If the tank pressure exceeds atmospheric pressure, the ECU24 initiates a pressure relief procedure before transitioning to the non-sealed setting by issuing an energizing (opening) instruction to the closing valve 40. The tank pressure is then gradually reduced by adjusting the opening amount of the closing valve 40. This adjustment is performed in response to the tank pressure, by referencing a map that correlates the tank pressure, the valve stroke amount of the closing valve 40, and the purge flow rate. This process helps suppress a sudden outflow of fuel vapor from the fuel tank 15 to the vapor passage 26 when the closing valve 40 opens, thereby preventing the ORVR valve 29 from unintentionally closing, specifically avoiding sticking of its float.

At time T2, when the tank pressure drops to the atmospheric pressure, the tank pressure measurement and the pressure relief determination before changing to the non-sealed setting are stopped. Then, the full-open instruction is output to the closing valve 40 to shift the closing valve 40 to the fully open state. If the tank pressure is equal to the atmospheric pressure at time T1, the pressure relief determination before changing to the non-sealed setting is omitted, and the full-open instruction is immediately output to the closing valve 40 to shift the closing valve 40 to the fully open state.

When the closing valve 40 reaches its fully open state at time T3, the energizing instruction for the closing valve 40 ceases. This completes the transition of the operation of the sealed tank system 12 to the non-sealed country setting (non-sealed switching). Consequently, the closing valve 40 remains fully open without the stepping motor 44 being energized.

When the predetermined time to hold the closing valve 40 fully open has elapsed in a non-sealed country, the ECU 24 temporarily closes the closing valve 40 and then opens it. In a state where the closing valve 40 is in the fully open state in a non-sealed country, when the ECU 24 detects user operation of the fuel door release switch 32, the ECU 24 immediately unlocks the fuel door switch 34.

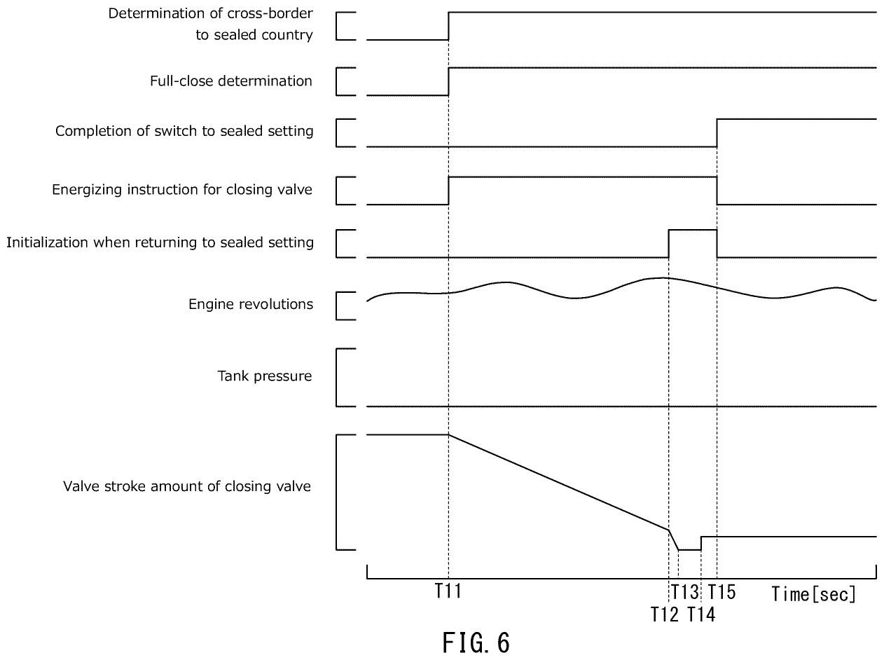

Next, the control by the ECU24 when the vehicle crosses from a non-sealed country to a sealed country is described. FIG. 6 is a time chart for the control by the ECU 24 when crossing the border from a non-sealed country to a sealed country. As shown in FIG. 6, at time T11, if the ECU 24 determines that the vehicle 10 has crossed the border to a sealed country based on the location information during engine operation, the ECU 24 determines the full-close of the closing valve 40. Then, the ECU 24 sends an energizing (closing) instruction to close the closing valve 40. Since the closing valve 40 is fully open in the non-sealed country, the tank pressure before crossing the border is equal to the atmospheric pressure.

When the seal member 64 of the closure member 48 of the closing valve 40 contacts the valve seat 56 at time T12, the ECU 24 starts the initialization of the closing valve 40. After the valve guide 46 contacts the valve seat 56 at time T13, the position where the stepping motor 44 loses synchronization at time T14 is set as the origin position of the stepping motor 44. Further, the position where the valve guide 46 leaves the valve seat 56 is set as the fully closed position of the stepping motor 44.

When the initialization is finished at time T15, the energizing instruction for the closing valve 40 is stopped to complete the switch of the sealed tank system 12 to the normal operation (sealed setting). As a result, the closing valve 40 is held in the fully closed state with the stepping motor 44 not energized.

The above-described embodiment has some advantages due to its characteristic features. In accordance with the sealed tank system 12, when the ECU 24 detects the cross-border of the vehicle 10 from a sealed country to a non-sealed country based on the location information output from the location information acquisition unit 70, the ECU 24 determines that the closing valve 40 is unnecessary. In such case, the ECU 24 maintains the closing valve 40 in the fully open state to switch the sealed tank system 12 to the non-sealed setting. Thus, it is possible to omit unnecessary operations of the sealed tank system 12 including unnecessary operations of the closing valve 40 and the depressurization of the fuel tank 15 before fueling. This can reduce power consumption and eliminate the waiting time for the tank pressure relief before fueling.

When the ECU 24 detects, based on the location information obtained from the location information acquisition unit 70, that the vehicle 10 has crossed the border from a non-sealed country into a sealed country, the ECU 24 determines that the closing valve 40 is required. In such case, the ECU 24 operates the closing valve 40 normally, switching the sealed tank system 12 to its sealed setting.

Thus, the operation of the sealed tank system 12 can be switched as the vehicle 10 moves between sealed and non-sealed countries. The operation of the sealed tank system 12 can be switched after the vehicle 10 has completely crossed the border, either by self-drive or by cargo ship transportation. The switching of the operation of the sealed tank system 12 is performed every time the border between sealed and non-sealed countries is crossed.

The closing valve 40 is composed of the electric valve that is equipped with the stepping motor 44. The opening amount of the closing valve 40 can be adjusted by controlling the stroke amount of the closure member 48. When stopping the energization to the stepping motor 44 in a state where the closing valve 40 is in the fully open state, the closing valve 40 is held in the fully open state. Thus, it is possible to reduce the power consumption of the closing valve 40 in non-sealed countries. Here, a normally closed-type solenoid valve is closed when not energized, and thus cannot keep the closing valve 40 open without energization.

The ECU 24 temporarily closes the closing valve 40 and then opens it when the closing valve 40 has been remained in the fully open state for a predetermined time. This preventive measure helps avoid malfunctions of the closing valve 40 like the closure member 48 sticking caused by age-related deterioration in non-closed countries. During this temporary closure, it is also recommended to perform the On-Board Diagnosis (OBD) of the closing valve 40, the so-called leak test. The temporary closing of the closing valve 40 can be either a full or partial close.

In non-sealed countries, the tank pressure is equivalent to the atmospheric pressure because the closing valve 40 is fully open. Thus, the ECU 24 immediately unlocks the fuel door switch 34 when detecting the operation of the fuel door release switch 32 in a state where the closing valve 40 is fully open. Accordingly, the user can open the fuel door 36 and refuel without waiting for the tank pressure relief before fueling.

The present disclosure is not limited to the embodiment described above, but can be implemented in various other forms. For example, in the embodiment, the closing valve 40 is fully opened when the ECU 24 determines that the closing valve 40 is unnecessary based on the location information from the location information acquisition unit 70. However, the opening amount of the closing valve 40 is not limited to the full-open, but can be in any open state including a half open state.

The present disclosure includes various aspects below. In a first aspect of this disclosure, a sealed tank system includes a canister capable of adsorbing and desorbing fuel vapor evaporated in a fuel tank of a vehicle, a vapor passage connecting the fuel tank to the canister, a purge passage connecting the canister to an intake passage of an engine, a control unit implemented by at least one programmed processor, a purge valve installed in the purge passage and controlled by the control unit, and a closing valve installed in the vapor passage and controlled by the control unit. The vehicle has a location information acquisition unit that acquires location information of the vehicle. When the control unit determines that the closing valve is not necessary based on the location information obtained by the location information acquisition unit, the closing valve is kept in an open state.

In accordance with the first aspect, when the control unit detects the cross-border of the vehicle from a sealed country to a non-sealed country based on the location information output from the location information acquisition unit to determine that the closing valve is unnecessary, the control unit maintains the closing valve in the open state to switch the sealed tank system to the non-sealed setting. Thus, unnecessary operations of the sealed tank system, such as unnecessary operations of the closing valve and the pressure relief of the fuel tank before fueling, can be omitted. Accordingly, it is possible to decrease power consumption and eliminate the waiting time for the tank pressure relief before fueling. On the other hand, when the control unit detects the cross-border of the vehicle from a non-sealed country to a sealed country based on the location information output from the location information acquisition unit to determine that the closing valve is necessary, the control unit carries out the normal operation of the closing valve to switch the sealed tank system to the normal setting. In this way, the operation of the sealed tank system can be switched based on the movement of the vehicle between sealed countries and non-sealed countries.

A second aspect of this disclosure is the sealed tank system of the first aspect, wherein the closing valve is an electric valve including a motor, wherein the closing valve is configured to control a stroke amount of a closure member of the closing valve to adjust an open amount of the closing valve, and wherein when the motor is not energized, the closing valve is maintained in the open state.

In accordance with the second aspect, it is possible to decrease the power consumption of the closing valve in non-sealed countries.

A third aspect of this disclosure is the sealed tank system of the first aspect, wherein the control unit is configured to temporarily close the closing valve and then open the closing valve when the closing valve is maintained open for a predetermined time.

In accordance with the third aspect, it is possible to suppress it is possible to prevent malfunctioning of the closing valve such as sticking of a closure member caused by age-related deterioration in non-closed countries. Further, the On-Board Diagnosis (OBD) of the closing valve, the so-called leak test, can be performed.

A fourth aspect of this disclosure is the sealed tank system of any one of the first to third aspects. The sealed tank system includes a fuel door covering a fuel inlet of the fuel tank and being movable between an open position and a closed position, a fuel door release switch connected to the control unit, and a fuel door switch locking the fuel door in the closed position. When the control unit detects an operation signal output from the fuel door release switch in a state where the closing valve is in the open state, the control unit immediately unlocks the fuel door switch.

In accordance with the fourth aspect, because the closing valve is kept in the open state in non-sealed countries, the tank pressure is equal to the atmospheric pressure. Thus, when the control unit detects the operation signal output from the fuel door release switch, the control unit immediately unlocks the fuel door switch. Accordingly, the user can open the fuel door and fuel without waiting the time for the tank pressure relief before fueling.

What is claimed is:

1. A sealed tank system, comprising:
a canister configured to adsorb and desorb fuel vapor evaporated in a fuel tank of a vehicle;
a vapor passage connecting the fuel tank to the canister;
a purge passage connecting the canister to an intake passage of an engine;
a control unit implemented by at least one programmed processor;
a purge valve installed in the purge passage and controlled by the control unit; and
a closing valve installed in the vapor passage and controlled by the control unit,
wherein the vehicle has a location information acquisition unit configured to acquire location information of the vehicle; and
wherein the control unit is configured to maintain the closing valve in an open state when the control unit determines that the closing valve is not necessary based on the location information obtained by the location information acquisition unit.

2. The sealed tank system of claim 1,
wherein the closing valve is an electric valve including a motor;
wherein the closing valve is configured to control a stroke amount of a closure member to adjust an open amount thereof; and
wherein the closing valve is maintained in the open state when the motor is not energized.

3. The sealed tank system of claim 1,
wherein the control unit is configured to temporarily close the closing valve and then open the closing valve when the closing valve has been maintained open for a predetermined time.

4. The sealed tank system of claim 1, further comprising:
a fuel door covering a fuel inlet of the fuel tank and being movable between an open position and a closed position;
a fuel door release switch connected to the control unit; and
a fuel door switch configured to lock the fuel door in the closed position,
wherein, when the control unit detects an operation signal output from the fuel door release switch while the closing valve is in the open state, the control unit immediately unlocks the fuel door switch.
